(19) United States
(12) Patent Application Publication
(10) Pub. No.: US 2006/0273603 A1
(43) Pub. Date: Dec. 7, 2006

(54) Fixing strip in the form of a pre-fabricated continuous section

(76) Inventor: Bernhard Kreye, Wunstorf (DE)

Correspondence Address: WILLIAM COLLARD;COLLARD & ROE, P.C., 1077 NORTHERN BOULEVARD, ROSLYN, NY, 11576, US

(21) Appl. No.: 10/557,442

(22) PCT Filed: Mar. 25, 2004
(86) PCT No.: PCT/DE04/00611

§ 371 Date: Nov. 18, 2005

(30) Foreign Application Priority Data
Mar. 20, 2003 (DE) 103-22-636.2

(51) Int. Cl. B60P 3/00

(52) U.S. Cl. 296/2

(57) ABSTRACT

The invention relates to a clip that is fixed to the surface of at least one glass pane of vehicle glazing, for retaining a functional element, in particular a seal, the element having a retaining section that can be locked in a positive fit with the clip. This clip has a cross-section in the form of a horizontal “U”, the outer face of a first limb of the “U” being configured as a connection surface that can be coated with adhesive and bonded to the corresponding surface of the pane. The clip is fixed to the pane surface in such a way that the limbs of the “U” extend towards the edge of the directly adjacent glass pane. The projecting retaining section of the functional element can be pressed into the clip, elastically extending the limbs of the “U”, from the direction of the edge of the glass pane.

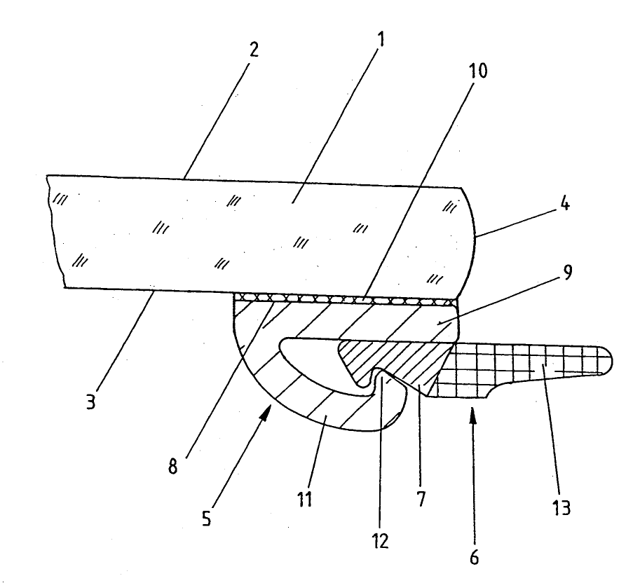

The invention relates to a clip that is attached to at least one pane surface of a glass pane of vehicle glazing for holding a functional element, particularly a seal, which has a holder section that can be engaged with the clip with a positive lock.

Clips that can be attached to glass panes, for holding a functional element that has a holder section that can be engaged with the clip with a positive lock, are known according to WO 01/08915 A1. The known clip has a swallowtail groove into which the holder section, which is also configured in swallowtail form, and is located on a seal, engages. Swallowtail groove and holder section are therefore engaged with one another with a positive lock, so that in the final analysis, the functional element is connected with the glass pane. The joining or engagement of swallowtail-shaped positive-lock elements is not entirely simple, in terms of assembly technology, and requires above-average care of the technician performing it.

The invention is based on the task of improving a clip to the effect that the functional element can be simply pressed into the clip, in terms of assembly technology, and nevertheless, sufficiently secure fixation of the functional element on the glass pane is assured.

This task is accomplished by means of the characteristics of claim 1. Further developments and advantageous embodiments of a clip result from the dependent claims 2 to 5.

Every clip has approximately the cross-sectional shape of a horizontal “U” or “V”. The outside of a U shank or V shank is configured as a connection surface that can be coated with adhesive and brought into contact with the related pane surface. The connection surface, and thereby the outside of the shank of the clip, in each instance, is therefore planar and can be advantageously dimensioned in such a manner that a secure adhesive connection with the glass pane, which can be calculated in advance, is assured. The clip is fixed in place on the pane surface in such a manner that the U shanks or V shanks spread open towards the directly adjacent edge of the glass pane.

The functional element has a holder section in its corresponding foot region. The holder section can be pressed in from the edge of the glass pane, under resilient elastic spreading of the U shanks or V shanks, into the clip that is attached or fixed in place on the glass pane.

This method of attachment by means of simple pressing in, overcoming a corresponding spring stress that is determined by the material for the clip, can be performed in simple manner, specifically by an employee, but also, in particularly advantageous manner, by an industrial robot that is programmed accordingly.

An engagement nose that can be moved with elastic resilience due to the elasticity of the material of the second U shank, which nose projects out relative to the first U shank, is disposed on the free end of the second U shank. This engagement nose narrows the opening gap between the U shanks in such a manner that a holder section that projects from the functional element can snap behind the engagement nose when the functional element is pressed into the clip with its holder section.

The shaping of the clip and of the holder section that is pressed into the clip is advantageously selected in such a manner that a residual pressure stress that results from the material of the clip can hold the functional element, once it has been pressed in, relatively securely and permanently.

Several clips can be disposed in a row, distributed along the edge of a glass pane. However, it is simpler, in terms of assembly technology, if a pre-finished clip bar that is present as an endless profile is used. A clip bar can be produced using the extrusion process, for example, in endless manner, preferably from polypropylene having a Shore hardness of about 40.

The functional part is generally produced from softer plastic, for example cellular rubber or the like, which is usual for seals.

The first U shank of the clip is coated with a hot-melt glue on the outside. When using a clip bar that is present as an endless profile, the hot-melt glue can be activated just before the clip rail is set onto the pane surface of a glass pane intended for this purpose, for example by means of heat.

Hot-melt glues have the advantage that they can be connected even with glass surfaces that have not been pre-treated, so that preparation of the glass pane, e.g. placement of adhesion promotion agents or similar coatings, is not necessary.

An exemplary embodiment of the invention, from which additional inventive characteristics are evident, is shown in the drawing.

The drawing shows a side view of the edge region of a glass pane 1 of a vehicle glazing in cross-section. The glass pane 1 has two pane surfaces 2 and 3, specifically the upper pane surface 2 and the lower pane surface 3. The face 4 that forms the edge of the glass pane 1 is located on the outer periphery of the glass pane 1.

A functional element 6 is held on the lower pane surface 3 by means of a clip 5. The functional element 6 is configured as a seal and has a holder section 7 that is engaged with the clip 5 with a positive lock.

The clip 5 has approximately the cross-sectional shape of a horizontal “U”, whereby the outside 8 of a first U shank 9 is configured as a connection surface coated with adhesive 10 and brought into contact with the assigned pane surface 3. The clip 5 is fixed in place on the pane surface in such a manner that the U shanks 9 and 11 spread apart towards the directly adjacent edge (face 4) of the glass pane 1, whereby the projecting holder section 7 of the functional element 6 can be pressed into the clip 5 from the edge of the glass pane 1, with resilient elastic spreading of the U shanks 9, 11.

An engagement nose 12 that projects towards the first U shank 9 is disposed on the free end of the second U shank 11.

The clip 5 is formed by a pre-finished clip bar that is present as an endless profile, the cross-sectional shape of which can be seen here. The material for the clip bar is polypropylene having a Shore hardness of about 40.

The material of the holder section 7 of the functional element 6 is also relatively hard, while the section 13 of the functional element 6 that serves as a seal can be soft cellular rubber. Holder section 7 and seal 13 of the functional element 6 can be produced using the co-extrusion process, so that an endless profile is also present in this regard.

Clip 5 and functional element 6 can accordingly be affixed to the glass pane and connected with one another in simple manner, in terms of assembly technology.

1. Clip that is attached to at least one pane surface of a glass pane of vehicle glazing for holding a functional element, particularly a seal, which has a holder section that can be engaged with the clip with a positive lock, wherein every clip (5) has approximately the cross-sectional shape of a horizontal “U”, whereby the outside of a first U shank (9) is configured as a connection surface that can be coated with adhesive (10) and brought into contact with the related pane surface (3), and that the clip (5) is fixed in place on the pane surface (3) in such a manner that the U shanks (9, 11) spread open towards the directly adjacent edge of the glass pane (1), whereby the projecting holder section (7) of the functional element (6) can be pressed in from the edge of the glass pane (1), under resilient elastic spreading of the U shanks (9, 11), into the clip (5).

2. Clip according to claim 1, wherein an engagement nose (12) that projects out relative to the first U shank (9) is disposed on the free end of a second U shank (11).

3. Clip according to claim 1, comprising a clip bar that is present as an endless profile.

4. Clip according to claim 1, wherein its material is polypropylene having a Shore hardness of about 40.

5. Clip according to claim 1, that wherein its first U shank (9) is coated with hot-melt glue on the outside.
